(19) United States
(12) Patent Application Publication
(10) Pub. No.: US 2021/0078255 A1
(43) Pub. Date: Mar. 18, 2021

(54) REFLECTOR ASSEMBLY FOR ADDITIVE MANUFACTURING

(71) Applicant: HEWLETT-PACKARD DEVELOPMENT COMPANY, L.P., Spring, TX (US)

(72) Inventors: Ferran ESQUIUS BERENGUERAS, Sant Cugat del Valles (ES); Esteve COMAS CESPEDES, Sant Cugat del Valles (ES); Ismael FERNANDEZ AYMERICH, Sant Cugat del Valles (ES); Arthur H. BARNES, Vancouver, WA (US)

(73) Assignee: HEWLETT-PACKARD DEVELOPMENT COMPANY, L.P., Spring, TX (US)

(21) Appl. No.: 17/050,316

(22) PCT Filed: Oct. 29, 2018
(86) PCT No.: PCT/US2018/057925

§ 371 Date: Oct. 23, 2020

(51) Int. Cl. B29C 64/277; B29C 64/153; B33Y 30/00; B22F 3/105

(52) U.S. Cl. CPC B29C 64/277; B29C 64/153; B22F 2003/1056; B22F 3/1055; B33Y 30/00

(57) ABSTRACT

A reflector assembly for an additive manufacturing apparatus comprises a first reflector comprising a first reflector section having a first reflecting surface and a second reflector comprising a second reflector section having a second reflecting surface. The first reflector section is for reflecting radiation from a first radiating element located, in use, proximate to the first reflecting surface, and the second reflector section is for reflecting radiation from a second radiating element located, in use, proximate to the second reflecting surface. The first reflector section and the second reflector section are each formed of a ceramic material.

### BACKGROUND

Some additive manufacturing systems, commonly referred to as 3D printers, use manufacturing materials and/or agents to build three-dimensional objects on a layer-by-layer basis.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 shows a schematic representation of an additive manufacturing system according to an example;

FIG. 2A shows a schematic representation of a reflector assembly according to an example;

FIG. 2B shows a perspective drawing of an example reflector section for an example reflector assembly;

FIG. 3 shows a schematic representation of an apparatus comprising a reflector assembly according to an example;

FIG. 4 shows a schematic representation of another apparatus comprising a reflector assembly according to an example;

FIG. 5 shows a schematic representation of the apparatus of FIG. 4 as it may be used in an additive manufacturing system described with reference to FIG. 1.

### DETAILED DESCRIPTION

Three-dimensional, 3D, printing, also referred to as additive manufacturing, rapid prototyping or solid freeform fabrication, is a technology which may be used for manufacturing a variety of objects. Some additive manufacturing systems generate three-dimensional objects through the selective solidification of successive layers of a build material, such as a powdered build material, liquid material or sheet material. Some such systems may solidify portions of a build material by selectively depositing an agent on a layer of build material. Some systems, for example, may use a liquid binder agent to chemically solidify build material where the liquid binder agent is applied.

Other systems, for example, may use liquid energy absorbing agents, or fusing agents, that cause build material to solidify when suitable radiation, such as infra-red radiation, is applied to build material on which a fusing agent has been applied. The temporary application of radiation may cause portions of the build material on which fusing agent has been delivered, or has penetrated, to absorb energy. This in turn causes these portions of build material to heat up above the melting point of the build material and to coalesce. Upon cooling, the portions which have coalesced become solid and form part of the three-dimensional object being generated.

Some example systems may use additional agents, such as detailing agents, in conjunction with fusing agents. A detailing agent is an agent that serves, for example, to modify the degree of coalescence of a portion of build material on which the detailing agent has been delivered or has penetrated. In examples, a detailing agent may produce a cooling effect at portions of the build material on which it is applied, thereby reducing the degree of coalescence upon the application of heat to that portion of build material. In some such examples, the cooling effect produced by the detailing agent may be such that the detailing agent prevents the portion of build material to which it is applied from heating up to a sufficient degree for coalescing of that portion to occur. In an example, a detailing agent may comprise mainly water. In examples, the detailing agent may be applied adjacent to portions of build material to which the fusing agent is applied, for example to control thermal bleed to portions of build material outside of the portion intended to be fused. In some examples, a detailing agent may be applied to portions of build material to which the fusing agent is also applied, for example, in order to control thermal aspects of the fusing of such a portion of build material upon the application of heat.

The production of a three-dimensional object through the selective solidification of successive layers of build material may involve a set of defined operations. An initial process may, for example, be to form a layer of build material from which a layer of the three-dimensional object is to be generated. A subsequent process may be, for example, to selectively deposit an agent, such as a fusing agent and/or detailing agent as described above, to selected portions of a formed layer of build material. In some examples, a further subsequent process may be to supply energy to the build material on which an agent has been deposited to solidify the build material in accordance with where the agent was deposited.

As described above, the temporary application of energy may cause portions of the build material on which an agent has been delivered, or has penetrated, to heat up above the point at which the build material begins to coalesce. This temperature may be referred to as the fusing temperature. Upon cooling, the portions which have coalesced become solid and form part of the three-dimensional object being generated. These stages may then be repeated to form a three-dimensional object. Other stages and procedures may also be used with this process.

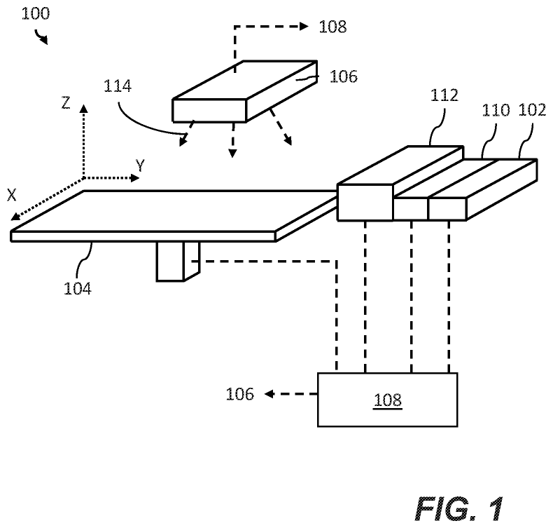

FIG. 1 is a schematic illustration of an additive manufacturing system 100 according to an example. The additive manufacturing system 100 includes a fusing agent distributor 102 to selectively deliver a fusing agent to successive layers of build material (not shown in FIG. 1) provided on a support member 104, an energy source 106, and a controller 108 to control the fusing agent distributor 102 to selectively deliver fusing agent to a layer of provided build material based on data derived from a 3D object model of an object to be generated. In some examples, the energy source 106 may also perform the function of pre-heating the build material to a particular temperature, for example prior to the energy source 106 applying heat for fusing portions of the build material. In other examples, in addition to the energy source 106, the system 100 may comprise an additional energy source (not shown), which may also be controlled by controller 108 and may provide the function of applying energy to the build material to uniformly raise the temperature of the build material to a particular temperature. The build material may be a powder-based build material. A powder-based material may be a dry or wet powder-based material, a particulate material, or a granular material, in some examples, the build material may include a mixture of air and solid polymer particles, for example at a ratio of about 40% air and about 60% solid polymer particles. Other examples of suitable build materials may include a powdered metal material, a powdered composite material, a powder ceramic material, a powdered glass material, a powdered resin material, a powdered polymer material, and combinations thereof, in other examples the build material may be a paste, a liquid, or a gel. According to one example, a suitable build material may be PA12 build material commercially known as V1R10A “HP PA12” available from HP Inc.

A suitable fusing agent may be an ink-type formulation comprising carbon black. Such an ink may additionally comprise an absorber that absorbs the radiant spectrum of energy emitted by the energy source 106. In one example where the fusing agent is an ink-type formulation comprising carbon black, the fusing agent may comprise the fusing agent formulation commercially known as V1Q60A “HP fusing agent”, available from HP Inc. In one example such an ink may additionally comprise a near infra-red light absorber. In one example such a fusing agent may additionally comprise a visible light absorber. In one example such an ink may additionally comprise a UV light absorber. Examples of inks comprising visible light enhancers are dye based colored ink and pigment based colored ink, such as inks commercially known as CE039A and CE042A available from HP Inc.

The support member 104 may be a fixed part of the additive manufacturing system 100 or may not be a fixed part of the additive manufacturing system 100, instead being, for example, a part of a removable module.

The agent distributor 102 may be a printhead, such as thermal print-head or piezo inkjet printhead. An example printhead may have arrays of nozzles, in other examples, the agents may be delivered through spray nozzles rather than through printheads. In some examples the printhead may be a drop-on-demand printhead. in other examples the printhead may be a continuous drop printhead. The agent distributor 102 may be an integral part of the additive manufacturing system 100 or may be user-replaceable. The agent distributor 102 may extend fully across the support member 104 in a so-called page-wide array configuration, in other examples, the agent distributor 102 may extend across a part of the support member 104. The agent distributor 102 may be mounted on a moveable carriage to enable it to move bi-directionally across the support member 104 along the illustrated y-axis. This enables selective delivery of fusing agent across the entire support member 104 in a single pass, in other examples the agent distributor 102 may be fixed, and the support member 104 may move relative to the agent distributor 102.

In some examples, there may be an additional agent distributor 110, in this example being a detailing agent distributor. The detailing agent may be selectively applied to portions of the build material which are not to be solidified and may be applied by the detailing agent distributor 110 in the manner described above for the fusing agent distributor. According to one example, a suitable detailing agent may be a formulation commercially known as V1Q61A “HP detailing agent” available from HP Inc. The fusing agent distributor 102 and the detailing agent distributor 110 may be located on the same carriage, either adjacent to each other or separated by a short distance. In other examples, two carriages each may contain fusing agent distributor 102 and detailing agent distributor 110.

The additive manufacturing system 100 further includes a build material distributor 112 to provide, e.g. deliver or deposit, successive layers of build material on the support member 104. Suitable build material distributors 112 may include a wiper blade and a roller. Build material may be supplied to the build material distributor 112 from a hopper or build material store. In the example shown the build material distributor 112 moves along the y-axis of the support member 104 to deposit a layer of build material. A layer of build material is deposited on the support member 104, and subsequent layers of build material are deposited on a previously deposited layer of build material. The build material distributor 112 may be a fixed part of the additive manufacturing system 100, or may not be a fixed part of the additive manufacturing system 100, instead being, for example, a part of a removable module.

In the example of FIG. 1 the support member 104 is moveable in the z-axis such that as new layers of build material are deposited a predetermined gap is maintained between the surface of the most recently deposited layer of build material and lower surface of the agent distributor 102. in other examples, however, the support member 104 may not be movable in the z-axis and, for example, the agent distributor 102 may be movable in the z-axis.

The energy source 106 applies energy 114 to build material to cause a solidification of portions of the build material, for example to portions to which an agent, e.g., fusing agent, has been delivered or has penetrated. In some examples, the energy source 106 is an infra-red radiation source, for example a near infra-red radiation source. The energy source 106 may comprise radiating elements, such as infra-red lamps. In an example, the energy source 106 may comprise a halogen radiation source. In examples, the energy source 106 is a scanning radiation source which is mounted on the moveable carriage (not shown). For example, the energy source 106 may apply energy to a strip of the whole surface of a layer of build material. In these examples the energy source 106 may be moved or scanned across the layer of build material such that a substantially equal amount of energy is ultimately applied across the whole surface of a layer of build material. In examples, the energy source 106 applies energy in a substantially uniform manner to the whole surface of a layer of build material, and a whole layer may have energy applied thereto simultaneously, which may increase the speed at which a three-dimensional object may be generated. In yet other examples, the energy source 106 may apply a variable amount of energy as it is moved across the layer of build material, for example in accordance with agent delivery control data. For example, the controller 108 may control the energy source 106 to apply energy to portions of build material on which fusing agent has been applied.

The energy source 106 includes a lamp or another radiating element to add or supply energy to the layers of build material. Two radiating elements, three radiating elements, or any number of radiating elements may be used side-by-side to increase the power per unit area irradiated onto the build material. Some lamps used as a radiating element in energy source 106 may include tungsten and to avoid blackening of the lamp due to tungsten condensation the lamp is operated above 300° C. Radiating elements of the energy source 106 used to fuse build material in examples described herein may be considered to act as a black body which is held at a constant, uniform temperature, so that the radiation has a spectrum and intensity depending on the temperature of the body in accordance with Planck's law, i.e., as the temperature decreases, the peak of the black-body radiation curve moves to lower intensities and longer wavelengths. In examples, portions of build material having a fusing agent applied thereto may have high absorptivity at wavelengths at which emission from the energy source peaks. Portions of build material to which a fusing agent has not been applied may absorb less of the radiation from the energy source 106. Where the energy source comprises lamps having filaments at a particular temperature, maintaining the filaments at that temperature, e.g. by applying a constant power to the radiating elements, may allow the range of wavelengths of radiation emitted by the source to be substantially constant and therefore allow control of the heating of portions of the build material.

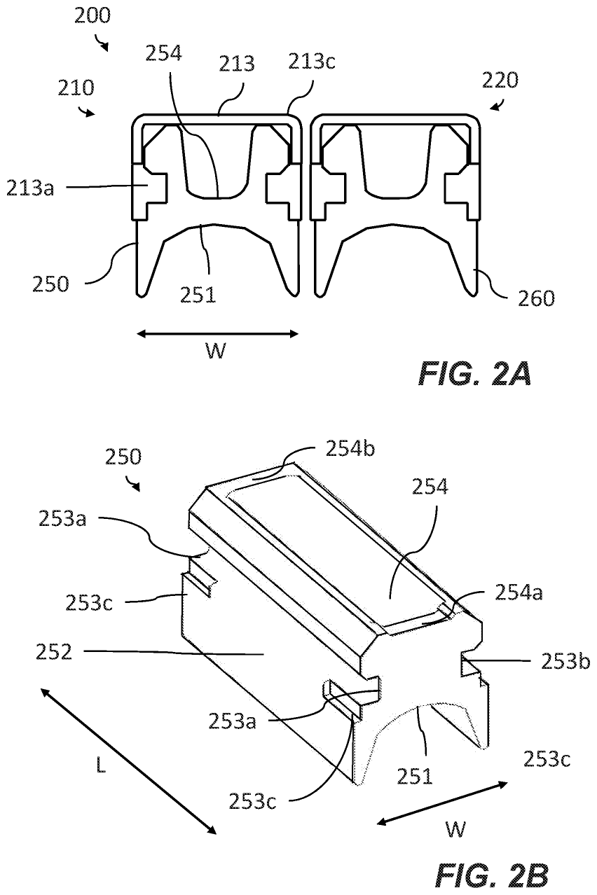

Examples provide a reflector assembly for the energy source 106, which may for example be a scanning energy source for applying radiation to a layer of build material, as described above. The use of a reflector assembly may increase a proportion of energy irradiated from the energy source 106 which is incident upon the layers of build material on the support member 104. FIG. 2A shows a cross-sectional schematic representation of an example reflector assembly 200 comprising a first reflector section 250 and a second reflector section 260. In this example, the reflector assembly 200 comprises a first reflector 210 and a second reflector 220, arranged side-by-side, with the first reflector section 250 arranged in the first reflector 210 and the second reflector section 260 arranged in the second reflector 220. Each reflecting section 250, 260 is formed of a ceramic material and comprises a respective reflecting surface 251. The reflecting sections 250, 260 in examples may be substantially identical to one another.

The first reflecting section 250 is shown in perspective view in FIG. 2B, and the second reflecting section 260 has the same features as will be described for the first reflecting section 250. The recess 254 of the reflecting section 250 can be seen in FIG. 2B to extend between a front wall 254a and a back wall 254b. It should therefore be noted that FIG. 2A shows a cross-sectional schematic representation of a central portion, i.e. at a point along the length L of the reflecting section 250 between the front wall 254a and the back wall 254b, of the reflecting section 250. The reflector section 250 has a reflecting surface 251 forming its lower face. In FIG. 2B a length of the reflecting section 250 is denoted as L and a width of the reflecting section 250 as W. The reflecting surface 251 extends along the length L. The length L may in examples be from 10 mm to 50 mm and may in an example be around 36 mm. The width W may be 10 mm to 30 mm, and in an example may be around 16 mm. A height H of the reflecting section 250 may be 10 mm to 30 mm, for example around 20 mm. A depth D of the reflecting section 251, i.e. a distance from a lowest point to a highest point of the reflecting surface may be 5 mm to 15 mm and may be around 10 mm.

In examples, each reflecting section 250, 260 is elongate and is substantially symmetrical about a central longitudinal axis of the reflecting section 250, 260. In the examples shown in the figures the reflecting surface 251 has a cross-section which is substantially elliptical in profile. That is, in this example the reflecting surface 251 extends substantially along the profile of a portion of an ellipse. The reflecting surface 251 may be made up of a plurality of straight portions, perpendicular to the direction L, substantially following the profile of an ellipse, or in another example may comprise a curved portion following the profile of an ellipse. In one example, the reflecting surface 251 is formed of two straight sections 251a and a curved section 251b joining the two straight sections 251a. In an example, the straight sections 251a extend downward at an angle of between 35 and 40° from one another and may in one example extend at around 38° from one another. In examples, the shape of the reflecting surface 251, e.g. whether the reflecting surface 251 comprises portions formed of straight sections of reflecting surface, may be chosen to provide for ease of manufacturing. The reflecting section 250 has a body 252 and has a recess 254 on its upper face. In examples, the reflecting surface 251 may be concave in shape and have a profile which is not elliptical, for example, the reflecting surface 251 may be hyperbolic. Upper corners 255 of the reflecting section 250 are beveled along the length L of the reflecting section 250. In FIG. 2A a cross-sectional view along the direction L of the reflecting sections 250, 260 is shown, wherein the recess 254 at the top face and the profile of the reflecting surface 251 at the lower face can be seen. The recess 254 may provide for decreasing the total mass of the reflecting section 250. The recess 254 may also provide for making available additional space in a reflector assembly, such as the reflector assembly 200, comprising the reflecting section 250. The reflecting section 250 comprises slots 253a, 253b, and 253c which are to allow the reflecting section 250 to be fitted in either of the reflectors 210, 220.

In the reflector assembly 200, the first reflector 210 comprises a housing 213 in which the first reflecting section 250 is mounted. Similarly, the second reflector 220 comprises a housing 223 in which the second reflecting section 260 is mounted. Each housing 213, 223, has mounting features 213a, 213b which correspond with slots 253a, 253b, 253c on the sides of the reflecting sections 250, 260. This allows each reflecting section 250, 260 to be mounted in the housing 213, 223. For example, each reflecting section 250, 260 may be removably mounted the respective housing 213, 223, for example by sliding each reflecting section 250, 260 into one of the housings 213, 223, along the direction L shown in FIG. 2B, with the slots 253a, 253b of a particular reflecting section 250 interacting with the mounting features 213a of the housing 213. Each housing 213, 223 also comprises an upper housing portion 213c covering the recessed upper face 254 of the reflecting sections 250, 260. The housing 213, 223 of each of the reflectors 210, 220 may be mounted to a support structure of an additive manufacturing system such as that shown in FIG. 1, for example, to a support structure provided in a 3D printer. As mentioned above, in examples where the reflector assembly is part of a scanning energy source, a movable carriage upon which the energy source may provide for scanning of the energy source over layers of build material on the support platform 104.

Examples provide for each reflector 210, 220 to comprise a plurality of reflector sections, such as reflector sections 250, 260, arranged end-to-end along the direction L. For example, the first reflector 210 and the second reflector 220 may each comprise two or more reflector sections 250, 260 arranged end-to-end along the direction L. As such, an elongate reflector made up of a plurality of stacked reflector sections 250 may be provided. This may provide for individual replacement of reflector sections 250, 260 in the reflector assembly 200. Furthermore, this can provide for a reflector assembly 200 of a particular length to be made up of separate reflector sections, such as reflector sections 250, arranged end-to-end along their lengths L.

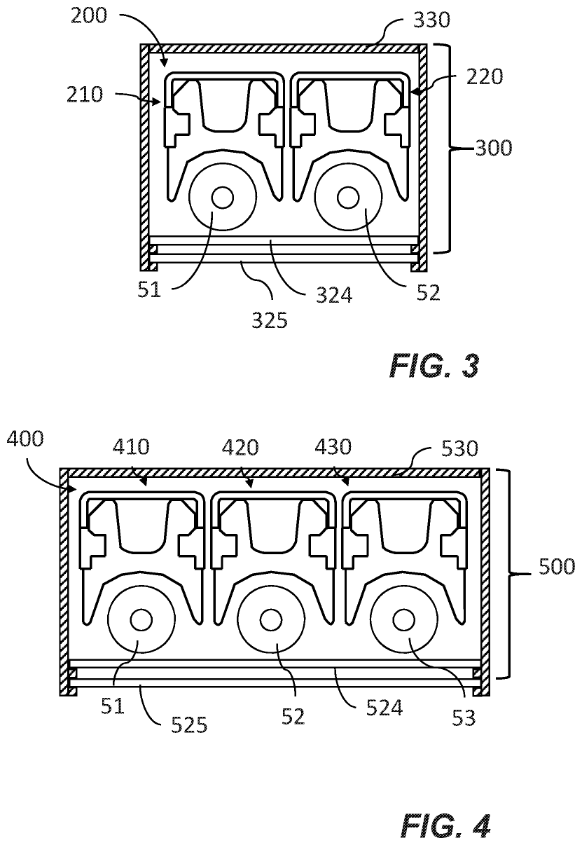

Now turning to FIG. 3, an apparatus 300 according to an example that may be used in an additive manufacturing system. The apparatus 300 comprises the reflector assembly 200 described with reference to FIG. 2A and FIG. 2B, and radiating elements 51, 52. The apparatus 300 may therefore be used as an energy source for an additive manufacturing system, such as the energy source 106 of FIG. 1. The first radiating element 51 is mounted proximate to, and in this example, beneath, the first reflector 210, and the first reflector 210 is to downwardly reflect energy from the first radiating element 51. Similarly, the second radiating element 52 is mounted proximate to, and beneath, the second reflector 220 which is to downwardly reflect energy from the second radiating element 52. The radiating elements 51, 52 are in examples elongate lamps arranged side-by-side beneath the reflector assembly 200. The radiating elements 51, 52 may include elongated lamps having an emission spectrum suitable for heating a powder material used in an adhesive manufacturing process, for example in the system 100 described above with reference to FIG. 1. In some examples the radiating elements 51, 52 are lamps having an emission spectrum peaking at an infra-red wavelength, for example around 1000 nm. In some examples the radiating elements 51, 52 are halogen lamps. Where the reflecting surfaces 251 of the reflecting sections are elliptically shaped, the radiating elements 51, 52 may be placed at respective focal points of these elliptically shaped surfaces, such that reflected radiation from the radiating elements 51, 52 is effectively reflected downwards. In an example, the ceramic reflecting sections 250, 260 have a peak of spectral reflectivity at a wavelength which is similar to a wavelength of peak emission from the radiating elements 51, 52, 53. For example, where the radiating elements have an emittance peak at around 1000 nm the ceramic reflecting sections 250, 260 may have a peak of reflectivity at around 1000 nm.

In accordance with further examples, the apparatus 300 comprises an outer housing 330 for containing the reflector assembly 200 and radiating elements 51, 52. In the example shown in FIG. 3 a first plate 324, for example a glass plate, and a second plate 325 below the first plate 324, also for example a glass plate, is provided beneath the lamps 51, 52, thereby creating an enclosed volume around the lamps 51, 52 keeping hot air inside the volume and preventing the lamps from running too cold. In an example, the first plate 324 is provided to act as an infra-red filter, for example absorbing parts of the IR spectrum which is not efficient for use in heating the build material. The second plate 325 may act to isolate the first plate 324 from the atmosphere created by the heating of the powder the first plate 324 and second plate 325 may be spaced to allow for circulation of air to cool both plates 324, 325.

Examples also provide for a reflector assembly which comprises a different number of reflectors to the two reflectors of the reflector assembly 200. As an example, FIG. 4 shows an apparatus 500 comprising another example reflector assembly 400 comprising three reflectors, 410, 420, 430 located side-by-side for reflecting energy from three radiating elements 51, 52, 53 mounted below respective reflectors of the reflector assembly 400. In this example, each reflector in the reflector assembly 400 and each radiating element may be as described for earlier example reflector assemblies. In yet another example, which is not shown in the figures, a reflector assembly may comprise one reflector for reflecting radiation from a single radiating element. In such an example, the reflector may comprise a plurality of reflecting sections 250 mounted end-to-end along a longitudinal axis of the reflector. As described with reference to FIG. 3, the apparatus 500 of FIG. 4 also comprises a first plate 524 and a second plate 525 beneath the radiating elements 51, 52, 53.

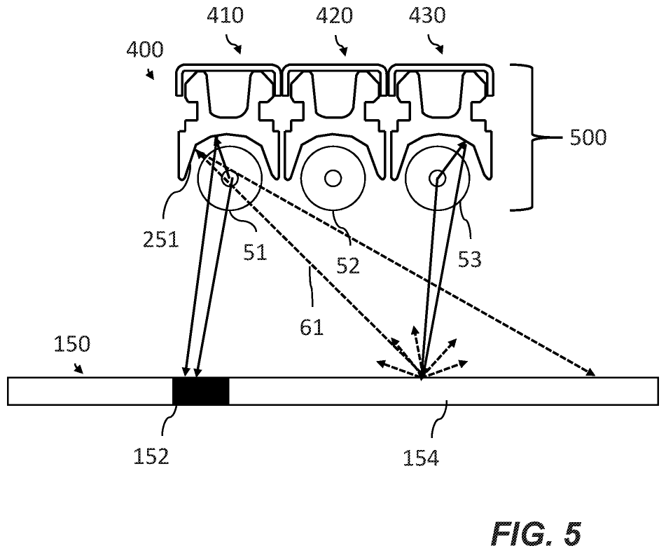

Examples provide for a reflector assembly which has a structure which can reduce the impact of back-reflection of radiation from the layer of build material on the uniformity of energy per unit area absorbed by parts of the build material. Referring now to FIG. 5, a schematic representation of the apparatus 500 of FIG. 4 is shown, arranged for irradiating a layer of build material 150. In an example, the layer of build material 150 may be on the support platform 104 in the system of FIG. 1. The apparatus 500 has the features described above with reference to FIG. 4 and earlier figures and description of these will not be repeated here. However, the outer housing 530 and plates 524, 525 are not shown in FIG. 5 for the purposes of clarity.

The layer of build material 150 comprises a first portion 152 of build material to be solidified and a surrounding portion 154 of build material which is not to be solidified. For example, the first portion 152 may be a portion to be solidified to form a 3D printed part while the surrounding portion 154 is the layer of powder surrounding the 3D printed part in the build layer 150. The first portion 152 of the layer of build material 150 is in this example more absorptive of radiation emitted from the apparatus 400 than the surrounding portion 154 of build material. That is because, as described above, an agent which increases absorption with respect to radiation applied by the radiating elements 51, 52, 53, i.e. fusing agent, is applied to the first portion 152 so that radiation may be absorbed by the first portion 152 to heat and thereby solidify the first portion 152. In an example, the fusing agent may be carbon black and the first portion 152 is consequently black after application of the fusing agent, while the surrounding portion 154 of build material comprises a substantially white powder. As such, with respect to the radiation incident on the build layer 150 from the energy source apparatus 500, the absorptivity of the first portion 152 is larger than the absorptivity of the surrounding portion 154, and correspondingly, the reflectivity of the surrounding portion 154 is larger than the reflectivity of the first portion 152.

FIG. 5 illustrates various paths of radiation originating from the energy source apparatus 500 and being reflected from the reflector assembly 400 and the build layer 150. Solid arrows represent radiation which has either directly originated from a radiating element or has originated from a radiating element and has been reflected from the reflector assembly 400. Dashed arrows represent radiation which has reflected back from the build layer 150 and radiation which has reflected back from the build layer 150 and has subsequently re-reflected from the reflector assembly 400.

Example reflector assemblies described herein, such as the reflector assembly 400, when used as shown in FIG. 5 to reflect radiation from one or more radiating elements for heating a layer of build material 150, provide for the spatial distribution of radiation which is back-reflected from the build layer 150 and subsequently reflected back from the reflector assembly 400 to be controlled. For example, each reflector 410, 420, 430 may act as an individual reflector for each radiating element 51, 52, 53 and have the effect that radiation emitted by the radiating element 51, 52 or 53 associated with the respective reflector 410, 420 or 430 is substantially contained to the area of the build layer 150 beneath that reflector. For example, most of the radiation incident on the first portion 152 may be radiation which originates from the first radiating element 51, which is located adjacent to the first reflector 410. The providing of separate reflectors 410, 420, 430 for each radiating element 51, 52, 53 may provide for this effect of controlling the directivity of emitted radiation. In this example, each reflector 410, 420, 430 is elongate and each radiating element 51, 52, 53 is elongate. As mentioned above, each reflecting surface 251 in this example is substantially symmetrical about a central longitudinal axis and thus a distribution of reflected radiation from each reflector 410, 420, 430 may be substantially symmetrical about a central longitudinal axis of each reflector. Where there is stray reflected radiation, as represented by the arrow labelled 61 in FIG. 5, the arrangement may also provide for the majority of such stray reflected radiation to be reflected out of the build layer area as shown. As such, uneven heating of portions of the build layer due to back-reflection may be minimized by examples described herein.

The radiating elements 51, 52, 53 may be placed close the ceramic reflecting surfaces 251 which may provide for a reflecting geometry which achieves the above-described effect of substantially containing reflected radiation to the area beneath each reflector 410, 420, 430. The use of ceramic reflecting sections, such as ceramic reflector section 250, may allow the radiating elements 51, 52, 53 to be placed in close proximity with the reflecting surfaces 251, for example, without active cooling of the ceramic reflector sections. An example ceramic reflector section 250, due to its thermal and reflective properties, may maintain its shape at high temperatures which result from a radiating element being located in close proximity with the reflecting surface 251, and continue to act as an effective reflector at such temperatures without the use of active cooling. Furthermore, the use of a described arrangement comprising a plurality of ceramic reflector sections 250 provides for a compact apparatus 500 comprising the reflector assembly 400 and radiating elements 51, 52, 53, which can be located close to the build layer 150 in use, which may contribute to controlling the reflection of radiation as described above. The absence of active cooling for such a reflector assembly 400 may also provide for a compact apparatus 500, for example an apparatus which is moveable above a layer of build material 150.

As mentioned above, in an example reflector assembly 500 and in other example reflector assemblies described herein, radiating elements 51, 52, 53 may be placed close to the respective reflecting surface 251 of each reflector since the reflecting surface 251 is part of a ceramic reflector section 250. In examples described herein, for example where the radiating elements 51, 52, 53 are lamps, each reflecting surface 251 of the reflectors 410, 420, 430 may be at a distance of from 1 mm to 5 mm, or from 2 mm to 4 mm from the radiating elements 51, 52, 53. For example, each reflecting surface 251 may be around 2.5 mm from a surface of one of the radiating elements 51, 52, 53. In the example shown in FIG. 5, the reflector assembly 400 may be placed, at a closest point between the reflector assembly 400 and the layer of build material 150, from 30 mm to 50 mm from the layer of build material 150, or from 35 mm to 45 mm from the layer of build material 150, and in one example at around 40 mm from the layer of build material 150. As mentioned above, the controlling of back-reflected radiation which is provided for by example reflector assemblies described herein may allow more even heating of absorptive parts in a 3D object may be achieved. In an example, heating of absorptive portions in different layers of a 3D object using an example reflector assembly such as reflector assembly 400 may be achieved such that there is no more than around 2-3 degrees Celsius between absorptive portions in different layers of build material. More equal heating of parts of the build material can give a higher degree of control over the solidification of those parts and result in higher dimensional accuracy for solid parts produced, and mechanical properties and a look and feel for those parts which is more consistent between layers.

In examples, reflecting sections, such as reflecting section 250, as mentioned above, are formed of a ceramic material and may be formed, for example, by ceramic injection molding. Example ceramic reflecting sections may be formed of zirconia-toughened alumina, ZTA.

Examples of reflector assemblies in the present disclosure have been described in the context of additive manufacturing using a bed of build material. It should be appreciated that an example reflector assembly according to the present disclosure, such as reflector assembly 200 or 400, may be used in other types of additive manufacturing process, such as a process that uses lamps for melting, such as high-speed sintering, or a process of heating, e.g. to perform a thermal curing operation. Examples described herein may be employed in a 2D or 3D printing operation.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

1. A reflector assembly for an additive manufacturing apparatus, the reflector assembly comprising:
a first reflector comprising a first reflector section having a first reflecting surface; and
a second reflector comprising a second reflector section having a second reflecting surface;
wherein the first reflector section is for reflecting radiation from a first radiating element located, in use, proximate to the first reflecting surface, and wherein the second reflector section is for reflecting radiation from a second radiating element located, in use, proximate to the second reflecting surface; and wherein
the first reflector section and the second reflector section are each formed of a ceramic material.

2. The reflector assembly of claim 1, wherein the first reflector and the second reflector are each elongate and are situated side-by-side in the reflector assembly, wherein the first reflector is for reflecting radiation from an elongate first radiating element, and the second reflector is for reflecting radiation from an elongate second radiating element.

3. The reflector assembly of claim 2, wherein the first reflector comprises a first housing in which the first reflector section is removably mounted and the second reflector comprises a second housing in which the second reflector section is removably mounted.

4. The reflector assembly of claim 1 wherein the first reflector comprises a first housing and a further reflector section mounted end-to-end with the first reflector section in the first housing, and the second reflector comprises a second housing and a further reflector section mounted end-to-end with the second reflector section in the second housing.

5. The reflector assembly of claim 4, wherein the first reflector section, second reflector section and further reflector sections are substantially identical to one another.

6. The reflector assembly of claim 1 wherein the first reflecting surface and the second reflecting surface are each substantially elliptically shaped reflecting surfaces.

7. The reflector assembly of claim 1 wherein the first reflecting surface and the second reflecting surface are each elongate and each has a longitudinal axis about which each reflecting surface is substantially symmetrical.

8. The reflector assembly of claim 1 comprising a third reflector situated side-by-side with the first and second reflectors, the third reflector comprising a third reflector section formed of a ceramic material.

9. The reflector assembly of claim 1 wherein the ceramic material from which each reflector section is formed is zirconia-toughened alumina.

10. A reflector assembly for an additive manufacturing system comprising a first reflector for reflecting radiation from a first radiating element and a second reflector for reflecting radiation from a second radiating element, the first reflector and the second reflector each comprising a reflector section formed of a ceramic material.

11. An apparatus comprising:
a reflector assembly comprising a first reflector comprising a first reflector section having a first reflecting surface; and a second reflector comprising a second reflector section having a second reflecting surface; wherein the first reflector section is for reflecting radiation from a first radiating element located, in use, proximate to the first reflecting surface, and wherein the second reflector section is for reflecting radiation from a second radiating element located, in use, proximate to the second reflecting surface; and wherein the first reflector section and the second reflector section are each formed of a ceramic material;
a first radiating element arranged proximate to the first reflecting surface such that radiation emitted by the first radiating element is reflected by the first reflecting surface; and
a second radiating element arranged proximate to the second reflecting surface such that radiation emitted by the second radiating element is reflected by the second reflecting surface.

12. The apparatus of claim 11 wherein reflecting surfaces of each of the first and second reflectors are elliptically shaped, and the first radiating element is located at a focal point of the first reflecting surface, and the second radiating element is located at a focal point of the second reflecting surface.

13. The apparatus of claim 11 wherein the reflector assembly comprises a third reflector comprising a third reflecting section having a third reflecting surface, the apparatus further comprising a third radiating element arranged proximate to the third reflecting surface such that radiation emitted by the third radiating element is reflected by the third reflecting surface.

14. An additive manufacturing system, comprising:
an energy source to apply energy to a build material to cause a solidification of printed portions of the build material;
wherein the energy source includes:
a first radiating element;
a second radiating element; and
a reflector assembly comprising a first reflector section formed of a ceramic material and a second reflector section formed of a ceramic material; wherein
the first radiating element is arranged proximate to the first reflector section such that radiation emitted by the first radiating element is reflected by the first reflector section; and
the second radiating element is arranged proximate to the second reflector section such that radiation emitted by the second radiating element is reflected by the second reflector section.

15. The additive manufacturing system of claim 14 wherein, when the energy source applies energy to the build material,
the reflector assembly and the build material are separated by a distance of from 30 mm to 50 mm at a closest point between the reflector assembly and the build material and/or
the first radiating element is arranged at a distance of from 2 mm to 4 mm from the first reflector section and/or the second radiating element is arranged at a distance of from 2 mm to 4 mm from the second reflector section.
